(19) United States
(12) Patent Application Publication
(10) Pub. No.: US 2026/0303912 A1
(43) Pub. Date: Oct. 1, 2026

(54) METHOD, APPARATUS, DEVICE, AND STORAGE MEDIUM FOR INTERFACE INTERACTION

(71) Applicant: Bytedance Technology Ltd., Grand Cayman (KY)

(72) Inventors: Jinyi Wang, Beijing (CN); Chujie Zhang, Beijing (CN)

(21) Appl. No.: 19/635,179

(22) Filed: Mar. 31, 2026

(30) Foreign Application Priority Data
Mar. 31, 2025 (CN) 202510397002.7

(51) Int. Cl. H04N 21/466; H04N 21/431; H04N 21/4788

(52) U.S. Cl. CPC H04N 21/4668; H04N 21/4316; H04N 21/4788

(57) ABSTRACT

The embodiment of the disclosure relates to a method, an apparatus, a device, and a computer-readable storage medium for interface interaction. The method provided by the disclosure includes: presenting, in a first viewing interface of a first feed, first media content in the first feed; presenting, in an interaction panel of the first media content, at least one content item and a viewing entry associated with the first media content, the at least one content item indicating a recommendation operation on the first media content by a corresponding user; and presenting, in response to a trigger for the viewing entry, a second viewing interface of a second feed, the second feed comprising a group of media content recommended by a group of users associated with a current user.

### CROSS REFERENCE

This application claims priority to Chinese Patent Application No. 202510397002.7, filed on Mar. 31, 2025, and entitled “METHOD, APPARATUS, DEVICE, AND STORAGE MEDIUM FOR INTERFACE INTERACTION”, the entirety of which is incorporated herein by reference.

### FIELD

Example embodiments of the present disclosure generally relate to the field of computers, and in particular, to a method, an apparatus, a device, and a computer-readable storage medium for interface interaction.

### BACKGROUND

In recent years, with the development of Internet technologies, more and more users perform interactive activities in a network platform. For example, activities such as posting or browsing media content, recommending or commenting on media content in a network platform. In this scenario, the user may be more interested in the media content posted or interacted with by their friends or followers, and how to efficiently consume the media content becomes the next core problem.

### SUMMARY

In a first aspect of the present disclosure, a method for interface interaction is provided. The method includes: presenting, in a first viewing interface of a first feed, first media content in the first feed; presenting, in an interaction panel of the first media content, at least one content item and a viewing entry associated with the first media content, the at least one content item indicating a recommendation operation on the first media content by a corresponding user; and presenting, in response to a trigger for the viewing entry, a second viewing interface of a second feed, the second feed including a group of media content recommended by a group of users associated with a current user.

In a second aspect of the present disclosure, an apparatus for interface interaction is provided. The apparatus includes: a first presenting module configured to present, in a first viewing interface of a first feed, first media content in the first feed; a second presenting module configured to present, in an interaction panel of the first media content, at least one content item and a viewing entry associated with the first media content, the at least one content item indicating a recommendation operation on the first media content by a corresponding user; and a third presenting module configured to present a second viewing interface of a second feed in response to a trigger for the viewing entry, the second feed including a group of media content recommended by a group of users associated with a current user.

In a third aspect of the present disclosure, an electronic device is provided. The device includes at least one processing unit; and at least one memory coupled to the at least one processing unit and storing instructions for execution by the at least one processing unit, the instructions, when executed by the at least one processing unit, causing the device to perform the method of the first aspect.

In a fourth aspect of the present disclosure, a computer-readable storage medium is provided. The computer-readable storage medium has stored thereon a computer program executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIGS. 2A-2I illustrate example interfaces according to some embodiments of the present disclosure;

FIG. 3 illustrates a flowchart of an example process of interface interaction according to some embodiments of the present disclosure;

FIG. 4 illustrates a schematic structural block diagram of an example apparatus for interface interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are only for illustrative purposes and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or in different sections/subsections.

In the description of the embodiments of the present disclosure, the terms “including” and the like should be understood as open-ended including, that is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below.

Embodiments of the present disclosure may relate to data of a user, obtaining and/or use of data, and the like. These aspects all follow the corresponding legal regulations and related provisions. In the embodiments of the present disclosure, all data is collected, obtained, processed, processed, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, if personal information processing is involved, processing may be performed on the premise of having a legality basis (for example, obtaining consent of a personal information subject, or necessary for performing a fulfillment contract), and processing only within a specified or agreed range. The user’s refusal to process personal information other than necessary information required for the basic function will not affect the user’ use of basic function.

As mentioned above, in recent years, with the development of Internet technologies, more and more users perform interactive activities in a network platform. For example, performing activities such as posting or browsing media content, recommending or commenting on media content in a network platform. In this scenario, the user may be more interested in the media content posted or interacted with by their friends or followers, and how to efficiently consume the media content becomes the next core problem.

Embodiments of the present disclosure provide a scheme for interface interaction. The scheme includes: presenting, in a first viewing interface of a first feed, first media content in the first feed; presenting, in an interaction panel of the first media content, at least one content item and a viewing entry associated with the first media content, the at least one content item indicating a recommendation operation on the first media content by a corresponding user; and presenting, in response to a trigger for the viewing entry, a second viewing interface of a second feed, the second feed including a group of media content recommended by a group of users associated with a current user.

In this way, the embodiments of the present disclosure can effectively improve the viewing efficiency of the information.

Various example implementations of this scheme are described in detail below in conjunction with the accompanying drawings.

### Example Environment

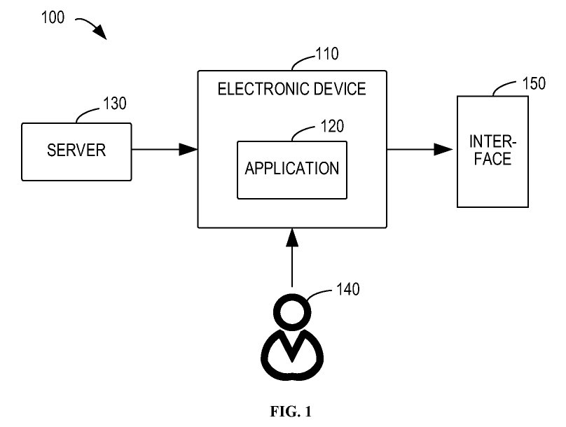

FIG. 1 illustrates a schematic diagram of an example environment 100 in which embodiments of the present disclosure can be implemented. As shown in FIG. 1, the example environment 100 may include an electronic device 110.

In the example environment 100, the electronic device 110 may run an application 120 that supports interface interaction. The application 120 may be any suitable type of application for interface interaction, examples of which may include, but are not limited to: a content sharing application, a social application, or other suitable application. The user 140 may interact with the application 120 via the electronic device 110 and/or attachment device thereof.

In the environment 100 of FIG. 1, if the application 120 is in an active state, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms, etc. The server 130 may include, for example, a computing system/server, such as a mainframe, an edge computing node, a computing device in a cloud environment, or the like. The server 130 may provide a background service for an application 120 supporting interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

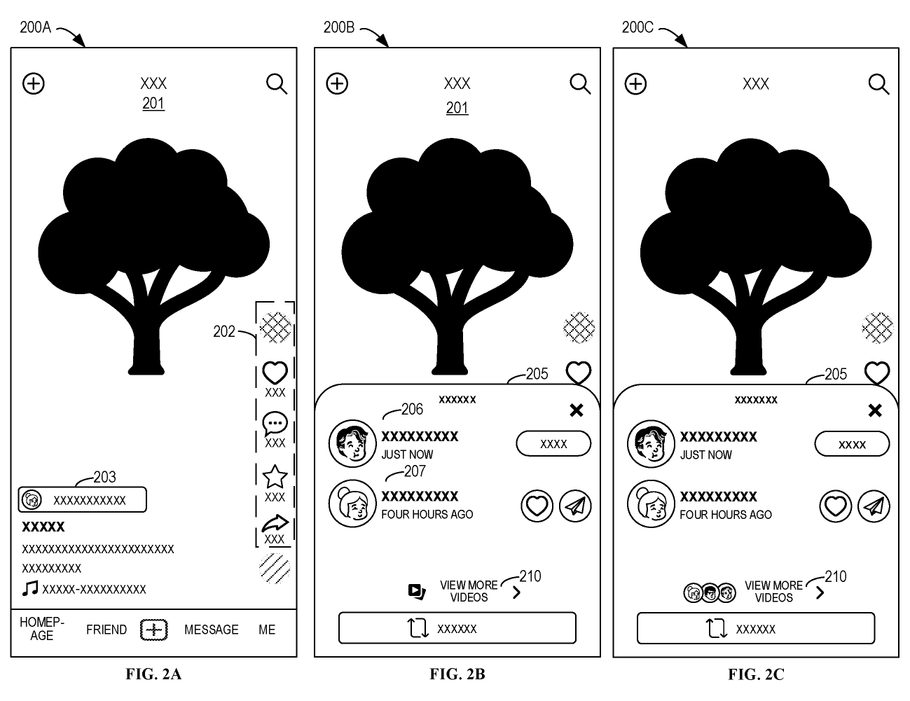

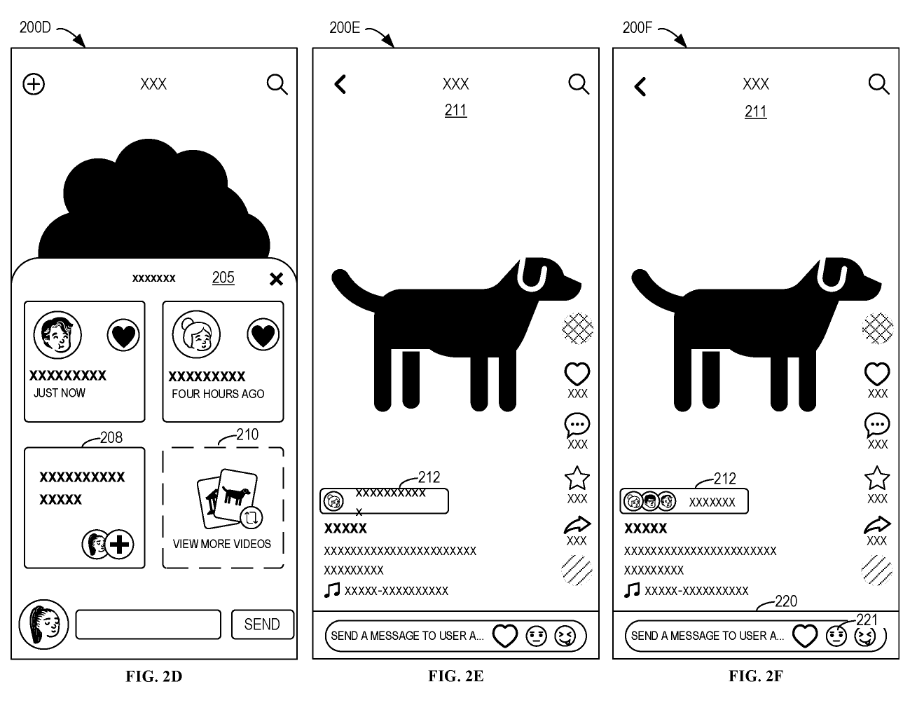

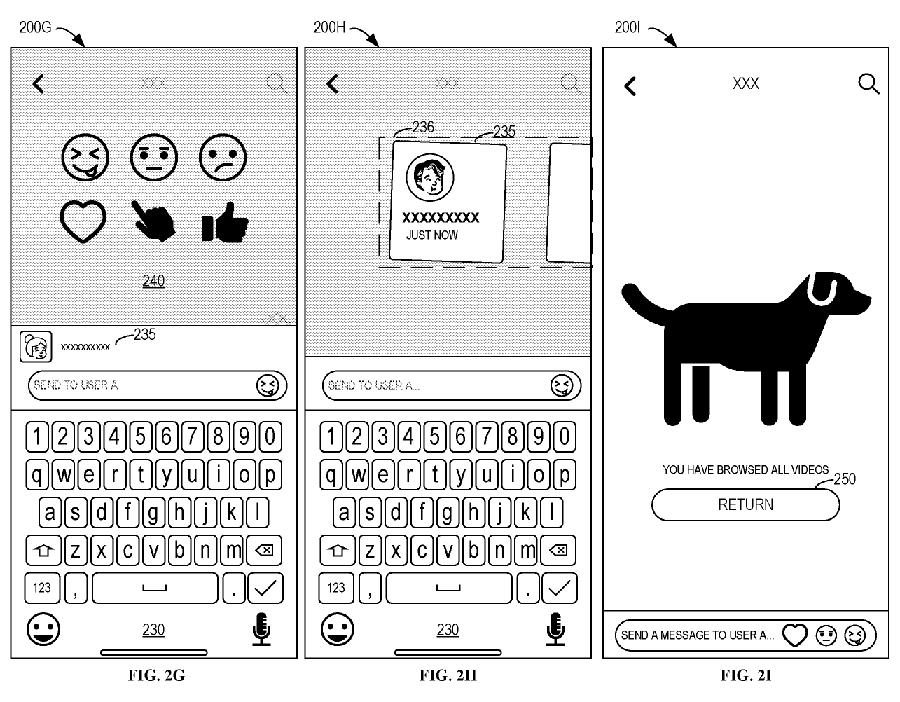

FIGS. 2A-2I illustrate example interfaces 200A- 200I according to some embodiments of the present disclosure. The interface 200A to the interface 200I may be provided, for example, by the electronic device 110 shown in FIG. 1.

As described above, with the rapid development of Internet technologies, users can post and browse media content in different network platforms (for example, content sharing platforms). In a process in which a user browses media content, a user may be more interested in media content recommended by their friends or followers.

How to efficiently browse media content recommended by others will be described in detail below.

In some embodiments, the electronic device 110 presents, in a first viewing interface of a first feed, first media content in the first feed. As an example, the first media content herein may be presented in the first feed, and the first feed may include a plurality of media contents posted by a plurality of users of a current application platform. The current application platform may be, for example, a content sharing platform, a social platform, or the like. The electronic device 110 may implement switching between the plurality of media contents in the first feed based on a content switching operation, such as an up-and-down swipe operation. The electronic device 110 may further interact with other users based on the interaction operation on the first media content by a current user. For example, like, comment, share, or the like may be performed on the first media content.

As shown in FIG. 2A, the electronic device 110 may present a first viewing interface 200A of the first feed. Association information 202 of the first media content 201 and the first media content 201 in the first feed is presented in the interface 200A. The association information 202 includes poster information, like information, comment information, collection information, and forward information of the first media content 201. The first media content 201 may be media content that is recommended by friends of the current user (users who follow the current user and the current user follows back) or followers (users who are followed by the current user). In some scenarios, the recommendation herein may also indicate that the current user's friends or followers have forwarded, liked, or commented.

In some embodiments, the electronic device 110 presents, in an interaction panel of the first media content, at least one content item and a viewing entry associated with the first media content. The at least one content item indicates a recommendation operation on the first media content by a corresponding user.

As an example, as shown in FIG. 2A, the electronic device 110 may present an element 203 in the first viewing interface 200A. The element 203 includes a user identifier of a corresponding user (for example, a first user). The user identifier herein may include, for example, an image identifier (for example, an avatar) and/or a text identifier (for example, a name) of the corresponding user (for example, the first user). The corresponding user (for example, the first user) may be a friend of the current user (a user who follows the current user and the current user follows back) or a follower (a user who is followed by the current user). In some scenarios, the electronic device 110 may also present, in the element 203, description information of an interaction operation on the first media content 201 by the first user. For example, if the interaction operation is a comment operation on the first media content 201 by the first user, the electronic device 110 may present, in the element 203, a portion of the comment content on the first media content 201 by the first user.

After the element 203 has been clicked by the current user, as shown in FIG. 2B, the electronic device 110 may present an interaction panel 205 of the first media content in an interface 200B. The interaction panel 205 includes at least one content item (for example, a content item 206 and a content item 207), and the at least one content item includes description information associated with the first media content. The description information herein includes a portion for describing a recommendation operation on the first media content 201 by a corresponding user. The content item 206 further includes an image identifier (for example, an avatar) and/or a text identifier (for example, a name) of the first user and time information of recommending the first media content 201 by the first user. In some scenarios, the electronic device 110 may also present a viewing entry 210 in the interaction panel 205, and the viewing entry 210 is configured to be triggered to present a second viewing interface of a second feed. In some scenarios, the electronic device 110 presents the viewing entry 210 in the interaction panel 205 only when media content is present in the second feed associated with the viewing entry 210. Conversely, the electronic device 110 will not present the viewing entry 210. In some other scenarios, as shown in FIG. 2D, the electronic device 110 may not only present at least one content item in the interaction panel 205 in a list style, but also present at least one content item in the interaction panel 205 in a card style.

Additionally or alternatively, as shown in FIG. 2D, the electronic device 110 may also provide a channel creation entry 208 to the current user in the interaction panel 205. The electronic device 110 may obtain a channel creation request of the current user via the channel creation entry 208, to create a session channel between the current user and other user selected by the current user based on the channel creation request. The other user selected by the current user herein may be, for example, a user corresponding to at least one content item in the interaction panel 205.

In some embodiments, the viewing entry further includes an image identifier of at least a portion of the group of users associated with the second feed. As an example, as shown in FIG. 2C, the electronic device 110 may also present image identifiers (for example, avatars) of a portion (for example, three users) of the group of users in the viewing entry 210. The portion of the users herein are associated with the second feed. In some scenarios, a portion of the users herein include the users presented in the content item in the interaction panel 205. In other scenarios, as shown in FIG. 2D, the electronic device 110 may also provide image content of a group of media content of the second feed to the user in the viewing entry 210. The image content herein may be, for example, a cover image of the group of media content.

In some embodiments, the electronic device 110 presents, in response to a trigger for the viewing entry, a second viewing interface of a second feed, the second feed including a group of media content recommended by a group of users associated with a current user. As an example, as shown in FIGS. 2B and 2E, when the viewing entry 210 is clicked by the current user, the electronic device 110 may present a second viewing interface 200E of the second feed. The second feed includes a group of media content, and the group of media content is recommended by a group of users. the association relationship between the group of users and the current user herein satisfies a preset condition. For example, the group of users herein is a friend of the current user (a user who follows the current user and the current user follows back) or a follower (a user who is followed by the current user). In this way, the embodiments of the present disclosure provide a viewing entry for the user, and the user can view the media content in the second feed through the viewing entrance, thereby improving the information obtaining efficiency.

In some embodiments, a time when the group of media content in the second feed is recommended by the group of users satisfies a preset condition. As an example, the server 130 first obtains a group of candidate media content recommended by a group of users. After obtaining the group of candidate media content, the server 130 may determine time information that the group of candidate media content is recommended by the group of users. Further, the server 130 may select, from the group of candidate media content, a group of media content whose time information satisfies the preset condition, to construct a second feed based on the group of media content. The preset condition herein may be, for example, media content recommended by the group of users within thirty days. The specific condition may be set by those skilled in the art according to requirements, which is not limited in the present disclosure.

In some embodiments, the electronic device 110 may provide the media content in the second feed to the current user in the second viewing interface, so that the current user can browse the media content in the second feed more conveniently and quickly. Specifically, the electronic device 110 may present the second media content in the second feed in the second viewing interface. Further, the electronic device 110 may present a first element in the second viewing interface, where the first element indicates that the second media content is recommended by at least one user of the group of users.

As an example, as shown in FIG. 2E, the electronic device 110 may present the second media content 211 in the second feed in a second viewing interface 200D. The second media content 211 is media content recommended by at least one user of a group of users. Further, the electronic device 110 may present a first element 212 in the second viewing interface. The first element 212 includes a user identifier of at least one user (for example, a second user) of the group of users. Taking the first element 212 being associated with the second user as an example, the user identifier herein may include, for example, an image identifier (for example, an avatar) and/or a text identifier (for example, a name) of the second user. The second user may be a friend of the current user (a user who follows the current user and the current user follows back) or a follower (a user who is followed by the current user). The first element 212 further includes description information for indicating that the second media content 211 is recommended by the second user. In some scenarios, the electronic device 110 may also present, in the first element 212, description information of an interaction operation on the second media content 211 by the second user. For example, if the interaction operation is a like operation on the second media content 211by the second user, the electronic device 110 may present, in the first element 212, description information associated with the like operation, where the description information herein may be, for example, “second user liked”.

As another example, as shown in FIG. 2F, the second media content 211 may also be media content recommended by a plurality of users of the group of users. When the second media content 211 is media content that is recommended by a plurality of users of the group of users, the electronic device 110 may present, in the first element 212, image identifiers (for example, avatars) and/or text content of a plurality of users who recommended the second media content 211. The text content herein is used to indicate how many users recommend the second media content 211, which may be, for example, “recommended by 3 people”.

In some embodiments, the electronic device 110 may provide an interaction component to the current user, and the interaction component is configured to enable the current user to quickly send a message to at least one user who recommended the second media content. Specifically, the electronic device 110 may present an interaction component in the second viewing interface. Further, the electronic device 110 may send, via the interaction component, an interaction message from the current user to a target user of the at least one user.

As an example, as shown in FIG. 2F, the electronic device 110 may provide the interaction component 220 to the current user in an interface 200F. The interaction component 220 is configured to send the interaction message to a target user of at least one user who recommended the second media content 211. Herein, the target user may be set by the electronic device 110 by default as the first user presented in the first element 212. The first user herein indicates the user corresponding to a first image identifier of the plurality of image identifiers in the first element 212 counted from left to right. After the electronic device 110 receives the interaction message sent by the current user to the target user via the interaction component 220, the electronic device 110 may send the interaction message to the target user. In some scenarios, the electronic device 110 may provide a plurality of interaction elements (for example, interaction elements 221) in the interaction component. After the interaction element 221 has been selected by the current user, the electronic device 110 may directly determine, based on the selected interaction element 221, an interaction message sent by the current user to the target user, to send the interaction message to the target user. In this way, the embodiment of the present disclosure provides, in the second viewing interface, the current user an entry to quickly interact with the target user, thereby improving the sending speed of the message.

In some embodiments, the electronic device 110 may present, in response to a trigger for the interaction component, an input panel in the second viewing interface, the input panel including a second element associated with the target user, and the second element including an image identifier and/or a text identifier associated with the target user.

As an example, as shown in FIG. 2F and FIG. 2G, after receiving a click on the interaction component 220 by the current user, the electronic device 110 may present an input panel 230 in an interface 200G. The input panel 230 includes a second element 235 associated with a target user. The second element 235 includes an image identifier (for example, an avatar) and a text identifier (for example, a name) of the target user. In this way, the embodiments of the present disclosure are able to notify the current user through the second element that an interaction message will be sent to the target user indicated by the second element, thereby improving the interaction experience of the user. In some scenarios, as shown in FIG. 2H, the electronic device 110 may also present the second element 235 in a card style.

In some other scenarios, after the interaction component 220 has been clicked by the current user, the electronic device 110 may further present an interaction element selection panel 240 in the interface 200F. The interaction element selection panel 240 includes a plurality of preset interaction elements, and the interaction elements herein may also be referred to as emoji elements. The plurality of emoji elements in the interaction element selection plane 240 may be a plurality of emoji elements whose usage times by the current user exceed a preset value within a preset time period. The current user may select a corresponding emoji element from the interaction element selection panel 240 to add the emoji element to the input panel 230.

In some embodiments, the electronic device 110 may determine the target user based on an interaction operation of the current user. Specifically, the electronic device 110 may obtain the interaction operation of the current user via the interaction component. Further, the electronic device 110 may determine the target user from the at least one user based on the interaction operation.

As an example, as shown in FIGS. 2G and 2H, after the second element 235 has been selected by the current user, the electronic device 110 may provide a selection component 236 to the current user. The selection component 236 includes a plurality of elements (for example, the second element 235) associated with a plurality of users recommending the second media content, respectively. After a target element (for example, the second element 235) of the plurality of content items has been selected, the electronic device 110 may determine, based on the selected target element (for example, the second element 235), the target user corresponding to the target element (for example, the second element 235), to send the interaction message to the target user. In this way, embodiments of the present disclosure are capable of supporting the current user to select a target user from a plurality of users recommending the second media content to interact with.

In some embodiments, after the current user has browsed all of a group of media content in the second feed, the electronic device 110 may provide a return entry to the current user to return to the first viewing interface. Specifically, after all of the group of media content in the second feed has been presented, the electronic device 110 presents a return control in the second viewing interface. Further, the electronic device 110 may present the first viewing interface of the first feed in response to a trigger for the return control. As an example, as shown in FIG. 2I, after all of the group of media content in the second feed has been presented, the electronic device 110 may present a return control 250 in a second viewing interface 200I. The return control 250 is configured to be triggered to present the first viewing interface of the first feed. When the return control 250 is triggered by the current user, the electronic device 110 may re-present the first viewing interface. In this way, the embodiments of the present disclosure can quickly switch the second viewing interface and the first viewing interface, thereby improving the display efficiency of the media content in different feeds.

In some embodiments, the electronic device 110 presents a last item of media content in the second feed in the second viewing interface. Further, the electronic device 110 may present, in response to receiving a swipe operation in a preset direction, a first item of media content in the second feed by switching the second viewing interface, and present the return control.

As an example, the last item of media content herein may be, for example, third media content, and the first item of media content may be, for example, second media content. After all of the group of media content in the second feed has been presented, the electronic device 110 may present the third media content (for example, the last item of media content) in the second viewing interface. Further, after the electronic device 110 receives a swipe operation (for example, a swipe down operation) in a preset direction, the electronic device 110 may switch the third media content presented in the second viewing interface to the second media content, and present the return control in the second viewing interface. An order of the first item of media content and the last item of media content is described below. In this way, the embodiments of the present disclosure can present to the current user that all media content in the second feed has been presented by switching between the last item of media content and the first item of media content, thereby improving the interaction experience of the user.

In some scenarios, when the electronic device 110 provides a group of media content in the second feed to the current user and presents all of the group of media content for the first time, the electronic device 110 may present blank content in the second viewing interface after receiving a swipe up operation in the preset direction.

In some embodiments, the server 130 may order the group of media content in the second feed. Specifically, the server 130 may determine an order of the group of media content based on browsing attributes of the group of media content. The browsing attributes include a browsing state and a browsing time. The browsing state indicates whether the group of media content was browsed by the current user, and the browsing time indicates a time when the group of media content was browsed by the current user.

As an example, after the server 130 obtains a group of media content recommended by a group of users, the group of media content may be ordered based on the browsing state and the browsing time. Specifically, the server 130 may order the media content that has not been browsed yet by the current user ahead of the media content that has been browsed by the current user in the group of media content. The browsing herein indicates that the current user has viewed the media content, including any suitable browsing scenarios such as searching, receiving forwarding of other users, and the like. For unread media content that has not been browsed by the current user, the server 130 may order it through any appropriate sorting algorithm. For example, the server 130 may order the unread media content based on the historical interaction information of the current user. For read media content that has been browsed by the current user, the server 130 may order it based on a time that the read media content was browsed by the current user.

In this way, the embodiments of the present disclosure can provide a viewing entry to the current user, so that the user can more conveniently view the media content in the second feed, thereby improving the viewing efficiency of the information.

### Example Processes

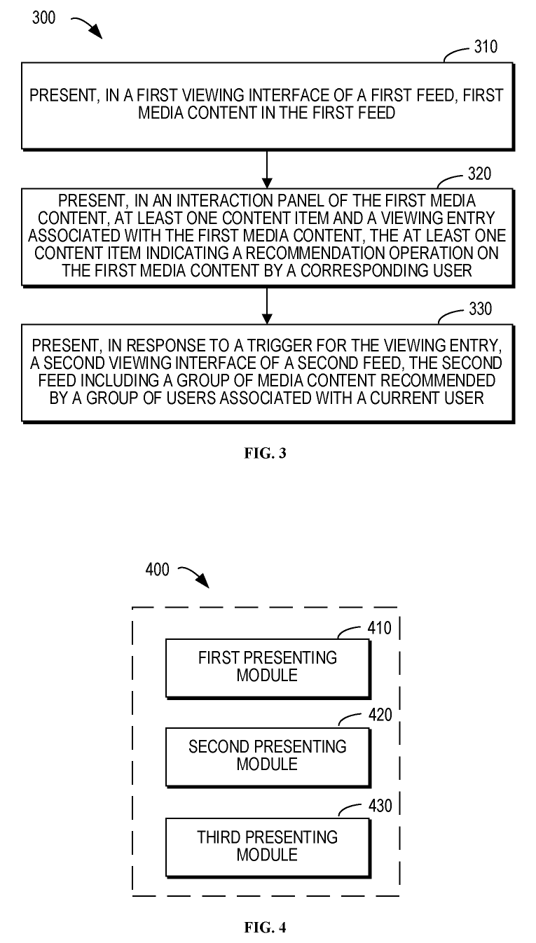

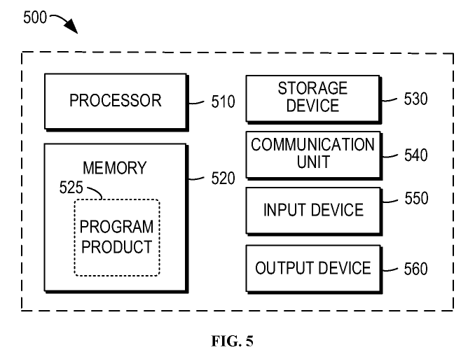

FIG. 3 illustrates a flowchart of an example process 300 of interface interaction according to some embodiments of the present disclosure. Process 300 may be implemented at electronic device 110. The process 300 is described below with reference to FIG. 1.

As shown in FIG. 3, at block 310, the electronic device 110 presents, in a first viewing interface of a first feed, first media content in the first feed.

At block 320, the electronic device 110 presents, in an interaction panel of the first media content, at least one content item and a viewing entry associated with the first media content, the at least one content item indicating a recommendation operation on the first media content by a corresponding user.

At block 330, the electronic device 110 presents, in response to a trigger for the viewing entry, a second viewing interface of a second feed, the second feed including a group of media content recommended by a group of users associated with a current user.

In some embodiments, the process 300 further includes: presenting second media content in the second feed in the second viewing interface; and presenting a first element in the second viewing interface, the first element indicating that the second media content is recommended by at least one user of the group of users.

In this way, the embodiments of the present disclosure can present the recommendation side of the second media content through the first element, thereby improving obtaining efficiency of the information.

In some embodiments, the process 300 further includes: presenting an interaction component in the second viewing interface; and sending, via the interaction component, an interaction message from the current user to a target user of the at least one user.

In this way, the embodiments of the present disclosure can send the interaction message more quickly to the target user, thereby improving sending efficiency of the message.

In some embodiments, the process 300 further includes: obtaining an interaction operation of the current user via the interaction component; and determining the target user from the at least one user based on the interaction operation.

In this way, embodiments of the present disclosure support a current user selecting a target user from at least one user to send an interaction message, thereby improving accuracy of message sending.

In some embodiments, the process 300 further includes: presenting, in response to a trigger for the interaction component, an input panel in the second viewing interface, the input panel including a second element associated with the target user, and the second element including an image identifier and/or a text identifier associated with the target user.

In this way, the embodiments of the present disclosure can present the target user to the current user through the second element, thereby improving the interaction experience of the user.

In some embodiments, the process 300 further includes: presenting a return control in the second viewing interface after all of the group of media content in the second feed has been presented; and presenting the first viewing interface of the first feed in response to a trigger for the return control.

In this way, after all the media content in the second feed has been presented, the embodiment of the present disclosure can quickly return the first viewing interface through the return control, thereby improving the efficiency of information viewing.

In some embodiments, presenting the return control in the second viewing interface after all of the group of media content in the second feed has been presented includes: presenting a last item of media content in the second feed in the second viewing interface; and presenting, in response to receiving a swipe operation in a preset direction, a first item of media content in the second feed by switching the second viewing interface, and presenting the return control.

In this way, the embodiments of the present disclosure can present to the current user that all media content in the second feed has been presented by switching between the last item of media content and the first item of media content, thereby improving the interaction experience of the user.

In some embodiments, an order of the group of media content in the second feed is determined based on browsing attributes of the group of media content.

In this way, the embodiments of the present disclosure can order the media content, thereby enabling the user to obtain a better interaction experience.

In some embodiments, the browsing attributes include at least one of the following: a browsing state indicating whether the group of media content was browsed by the current user; a browsing time indicating a time when the group of media content was browsed by the current user.

In this way, the embodiments of the present disclosure can enable a user to obtain a better interaction experience.

In some embodiments, a time when the group of media content in the second feed is recommended by the group of users satisfies a preset condition.

In this way, the embodiments of the present disclosure can filter media content whose time does not satisfy the preset condition, thereby improving the quality of the media content in the second feed.

In some embodiments, the viewing entry further includes an image identifier of at least a portion of the group of users associated with the second feed.

In this way, the embodiments of the present disclosure can effectively improve the user's interaction experience.

### Example Apparatus and Apparatus

Embodiments of the present disclosure also provide a corresponding apparatus for implementing the above method or process. FIG. 4 shows a schematic structural block diagram of an example apparatus 400 for interface interaction according to some embodiments of the present disclosure. The apparatus 400 may be implemented as or included in the electronic device 110. The various modules/components in the apparatus 400 may be implemented by hardware, software, firmware, or any combination thereof.

As shown in FIG. 4, the apparatus 400 includes: a first presenting module 410 configured to present, in a first viewing interface of a first feed, first media content in the first feed; a second presenting module 420 configured to present, in an interaction panel of the first media content, at least one content item and a viewing entry associated with the first media content, the at least one content item indicating a recommendation operation on the first media content by a corresponding user; and a third presenting module 430 configured to present, in response to a trigger for the viewing entry, a second viewing interface of a second feed, the second feed including a group of media content recommended by a group of users associated with a current user.

In some embodiments, the apparatus 400 further includes a first element presenting module configured to present second media content in the second feed in the second viewing interface; and present a first element in the second viewing interface, the first element indicating that the second media content is recommended by at least one user of the group of users.

In some embodiments, the apparatus 400 further includes a sending module configured to present an interaction component in the second viewing interface; and send, via the interaction component, an interaction message from the current user to a target user of the at least one user.

In some embodiments, the apparatus 400 further includes a determining module configured to obtain an interaction operation of the current user via the interaction component; and determine the target user from the at least one user based on the interaction operation.

In some embodiments, the apparatus 400 further includes a panel presenting module configured to present, in response to a trigger for the interaction component, an input panel in the second viewing interface, the input panel including a second element associated with the target user, and the second element including an image identifier and/or a text identifier associated with the target user.

In some embodiments, the apparatus 400 further includes a returning module configured to present a return control in the second viewing interface after all of the group of media content in the second feed has been presented; and present the first viewing interface of the first feed in response to a trigger for the return control.

In some embodiments, the returning module is further configured to present a last item of media content in the second feed in the second viewing interface; and present, in response to receiving a swipe operation in a preset direction, a first item of media content in the second feed by switching the second viewing interface, and present the return control.

In some embodiments, an order of the group of media content in the second feed is determined based on browsing attributes of the group of media content.

In some embodiments, the browsing attributes include at least one of the following: a browsing state indicating whether the group of media content was browsed by the current user; a browsing time indicating a time when the group of media content was browsed by the current user.

In some embodiments, a time when the group of media content in the second feed is recommended by the group of users satisfies a preset condition.

In some embodiments, the viewing entry further includes an image identifier of at least a portion of the group of users associated with the second feed.

The modules included in the apparatus 400 may be implemented in various manners, including software, hardware, firmware, or any combination thereof. In some embodiments, one or more modules may be implemented using software and/or firmware, such as machine-executable instructions stored on a storage medium. In addition to or as an alternative to machine-executable instructions, some or all of the elements in the apparatus 400 may be implemented, at least in part, by one or more hardware logic components. By way of example and not limitation, exemplary types of hardware logic components that may be used include field programmable gate arrays (FPGAs), application specific integrated circuits (ASICs), application specific standard products (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be used to implement the electronic device 110 as discussed above.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc. , communicate with one or more devices that enable a user to interact with the electronic device 500, or communicate with any device (e.g., a network card, a modem, etc. ) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce an apparatus to implement the functions/acts specified in one or more blocks in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement various aspects of the functions/acts specified in one or more blocks in the flowchart and/or block diagram.

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in one or more blocks in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for interface interaction comprising:
presenting, in a first viewing interface of a first feed, first media content in the first feed;
presenting, in an interaction panel of the first media content, at least one content item and a viewing entry associated with the first media content, the at least one content item indicating a recommendation operation on the first media content by a corresponding user; and
presenting, in response to a trigger for the viewing entry, a second viewing interface of a second feed, the second feed comprising a group of media content recommended by a group of users associated with a current user.

2. The method of claim 1, further comprising:
presenting second media content in the second feed in the second viewing interface; and
presenting a first element in the second viewing interface, the first element indicating that the second media content is recommended by at least one user of the group of users.

3. The method of claim 2, further comprising:
presenting an interaction component in the second viewing interface; and
sending, via the interaction component, an interaction message from the current user to a target user of the at least one user.

4. The method of claim 3, further comprising:
obtaining an interaction operation of the current user via the interaction component; and
determining the target user from the at least one user based on the interaction operation.

5. The method of claim 3, further comprising:
presenting, in response to a trigger for the interaction component, an input panel in the second viewing interface, the input panel comprising a second element associated with the target user, and the second element comprising an image identifier and/or a text identifier associated with the target user.

6. The method of claim 1, further comprising:
presenting a return control in the second viewing interface after all of the group of media content in the second feed has been presented; and
presenting the first viewing interface of the first feed in response to a trigger for the return control.

7. The method of claim 6, wherein presenting the return control in the second viewing interface after all of the group of media content in the second feed has been presented comprises:
presenting a last item of media content in the second feed in the second viewing interface; and
presenting, in response to receiving a swipe operation in a preset direction, a first item of media content in the second feed by switching the second viewing interface, and presenting the return control.

8. The method of claim 1, wherein an order of the group of media content in the second feed is determined based on browsing attributes of the group of media content.

9. The method of claim 8, wherein the browsing attributes comprise at least one of the following:
a browsing state indicating whether the group of media content was browsed by the current user; and
a browsing time indicating a time when the group of media content was browsed by the current user.

10. The method of claim 1, wherein a time when the group of media content in the second feed is recommended by the group of users satisfies a preset condition.

11. The method of claim 1, wherein the viewing entry further comprises an image identifier of at least a portion of the group of users associated with the second feed.

12. An electronic device comprising:
at least one processing unit; and
at least one memory coupled to the at least one processing unit and storing instructions for execution by the at least one processing unit, the instructions, when executed by the at least one processing unit, causing the electronic device to perform acts comprising:
presenting, in a first viewing interface of a first feed, first media content in the first feed;
presenting, in an interaction panel of the first media content, at least one content item and a viewing entry associated with the first media content, the at least one content item indicating a recommendation operation on the first media content by a corresponding user; and
presenting, in response to a trigger for the viewing entry, a second viewing interface of a second feed, the second feed comprising a group of media content recommended by a group of users associated with a current user.

13. The electronic device of claim 12, the acts further comprising:
presenting second media content in the second feed in the second viewing interface; and
presenting a first element in the second viewing interface, the first element indicating that the second media content is recommended by at least one user of the group of users.

14. The electronic device of claim 13, the acts further comprising:
presenting an interaction component in the second viewing interface; and
sending, via the interaction component, an interaction message from the current user to a target user of the at least one user.

15. The electronic device of claim 14, the acts further comprising:
obtaining an interaction operation of the current user via the interaction component; and
determining the target user from the at least one user based on the interaction operation.

16. The electronic device of claim 14, the acts further comprising:
presenting, in response to a trigger for the interaction component, an input panel in the second viewing interface, the input panel comprising a second element associated with the target user, and the second element comprising an image identifier and/or a text identifier associated with the target user.

17. The electronic device of claim 12, the acts further comprising:
presenting a return control in the second viewing interface after all of the group of media content in the second feed has been presented; and
presenting the first viewing interface of the first feed in response to a trigger for the return control.

18. The electronic device of claim 17, wherein presenting the return control in the second viewing interface after all of the group of media content in the second feed has been presented comprises:
presenting a last item of media content in the second feed in the second viewing interface; and
presenting, in response to receiving a swipe operation in a preset direction, a first item of media content in the second feed by switching the second viewing interface, and presenting the return control.

19. The electronic device of claim 12, wherein an order of the group of media content in the second feed is determined based on browsing attributes of the group of media content.

20. A non-transitory computer-readable storage medium having stored thereon a computer program executable by a processor to implement acts comprising:
presenting, in a first viewing interface of a first feed, first media content in the first feed;
presenting, in an interaction panel of the first media content, at least one content item and a viewing entry associated with the first media content, the at least one content item indicating a recommendation operation on the first media content by a corresponding user; and
presenting, in response to a trigger for the viewing entry, a second viewing interface of a second feed, the second feed comprising a group of media content recommended by a group of users associated with a current user.
